(19) United States
(12) Patent Application Publication
(10) Pub. No.: US 2004/0047991 A1
(43) Pub. Date: Mar. 11, 2004

(54) Resin coated carrier fabrication method and the related apparatus for the fabrication

(75) Inventors: Ching-I Yu, Bade City (TW); Lang-Ching Chih, Taoyuan (TW); Kang-Tsun Liu, Miaoli (TW); Kung-Ming Yen, Pingjen City (TW)

Correspondence Address: BACON & THOMAS, PLLC, 625 SLATERS LANE, FOURTH FLOOR, ALEXANDRIA, VA, 22314

(73) Assignee: S & S Technology Corp., Taoyuan (TW)

(21) Appl. No.: 10/238,730

(22) Filed: Sep. 11, 2002

(51) Int. Cl. B05D 1/28; B05D 5/10; B05C 11/02; B05C 1/00; B05D 5/00

(52) U.S. Cl. 427/256; 427/207.1; 427/428; 118/100; 118/110; 118/209

(57) ABSTRACT

A resin coated carrier fabrication method and the related apparatus in which a metered material feeder is controlled to apply a bonding agent to the periphery of a continuously rotated material-transferring cylinder subject to a predetermined thickness and simultaneously a tape of carrier is extended over an impression cylinder, and then a driving mechanism is controlled to adjust the gap between the material-transferring cylinder and the impression cylinder for enabling the bonding agent to be transferred to the tape of carrier, leaving a blank area around the applied layer of bonding agent on the tape of carrier.

### BACKGROUND OF THE INVENTION

1. Field of the Invention

The present invention relates to the fabrication of a resin coated carrier for making a printed circuit board and, more particularly to a resin coated carrier fabrication method practical for making a resin coated carrier having a layer of resin and a blank area surrounding the layer of resin. The invention relates also to the apparatus for the application of the method.

2. Description of the Related Art

A resin coated carrier for making a printed circuit board according to the prior art is generally comprised of a carrier obtained from, for example, copper foil, and a layer of resin coated on the carrier. The resin coated copper foil thus obtained can be adhered to a substrate for processing into a printed circuit board through a series of procedures including exposure and etching. PET may also be used as a carrier instead of copper foil.

Either material is used for the carrier, the carrier is cut into a tape. After one side of the carrier has been coated with a layer of bonding agent (resin), the resin coated carrier is cut into equal pieces subject to the size of the substrate. Thereafter, two impression boards are pressed together keeping the resin coated carrier and the substrate sandwiched therebetween. When pressing the impression boards against each other, the resin is formed to disperse and to partially flow out of the resin coated carrier. The resin will attach to the surface of the impression boards which is very difficult to remove. In order to facilitate removal of the overflow of resin, a release film may be added between the resin coated carrier and the lens board at each side for absorbing the overflow of resin. The release film is thrown away after its service. However, an additional mechanism must be installed to control loading and removal of release films during the PC board manufacturing process. The use of such a mechanism complicates the PC board manufacturing process, and relatively increases the PC board manufacturing cost.

### SUMMARY OF THE INVENTION

The present invention has been accomplished under the circumstances in view. It is the main object of the present invention to provide a resin coated carrier fabrication method and the related apparatus for the fabrication, which is practical for fabricating a resin coated carrier having a layer of resin of uniform thickness and a blank area surrounding the layer of resin that eliminates the aforesaid resin overflow problem.

It is another object of the present invention to provide a resin coated carrier fabrication method and the related apparatus for the fabrication, which is practical for fabricating an inexpensive resin coated carrier that is easy to use.

To achieve these and other objects of the present invention, the resin coated carrier fabrication method comprises the steps of: (a) applying a layer of bonding agent to a periphery of a continuously rotated material-transferring cylinder subject to a predetermined thickness through a metered material feeder, and at the same time extending a tape of carrier over an impression cylinder and continuously delivering said tape of carrier forwards and keeping a predetermined gap between said tape of carrier and the periphery of said material-transferring cylinder; (b) adjusting the gap between said material-transferring cylinder and said carrier for enabling said bonding agent to be transferred from said material-transferring cylinder to said tape of carrier when the gap between said material-transferring cylinder and said carrier becomes smaller than the thickness of said layer of bonding agent at the periphery of said material-transferring cylinder and, for enabling a blank area to be left in said tape of carrier when the gap between said material-transferring cylinder and said carrier becomes greater than the thickness of said layer of bonding agent at the periphery of said material-transferring cylinder; and (c) repeating step (b) so as to form the tape of carrier into a resin coated carrier having a layer of the bonding agent on one side thereof surrounded by a blank area.

The resin coated carrier fabrication apparatus comprises a frame; a rack sliderably reciprocatly mounted on said frame; a material-transferring cylinder rotatably mounted on the rack; a metered material feeder adapted for applying a layer of bonding agent to a periphery of the material-transferring cylinder according to a predetermined thickness; an impression cylinder rotatably mounted on the frame and adapted for supporting a tape of carrier; and a driving mechanism adapted for reciprocating the rack on the frame to adjust the gap between the material-transferring cylinder and the impression cylinder.

### BRIEF DESCRIPTION OF THE DRAWINGS

FIG. 1 is a schematic drawing showing a resin coated carrier fabrication apparatus according to the first embodiment of the present invention.

FIG. 2 is an enlarged view of a part of the resin coated carrier fabrication apparatus according to the first embodiment of the present invention.

FIG. 3 is a schematic drawing showing a resin coated carrier made according to the present invention.

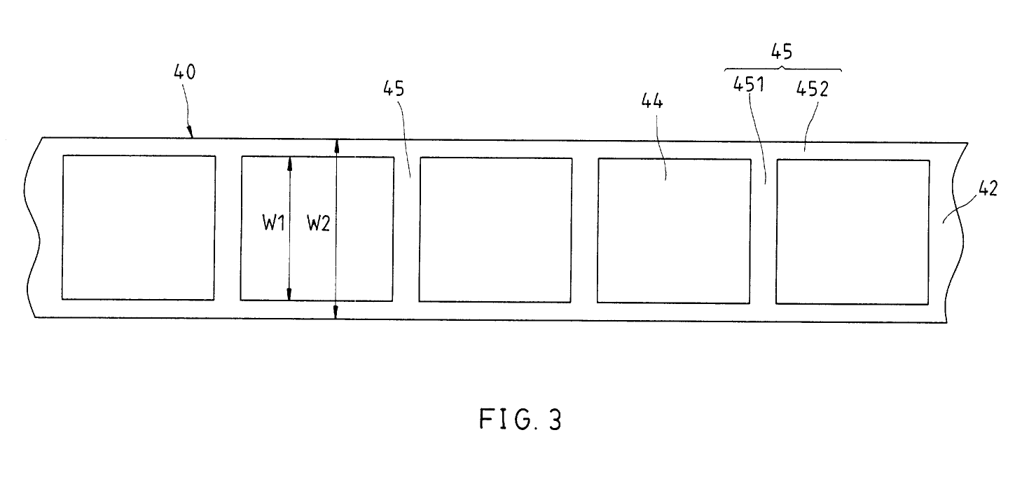

FIG. 4 is a schematic drawing showing a resin coated carrier fabrication apparatus according to the second embodiment of the present invention.

FIG. 5 is a schematic drawing showing a resin coated carrier fabrication apparatus according to the third embodiment of the present invention.

### DETAILED DESCRIPTION OF THE PREFERRED EMBODIMENT

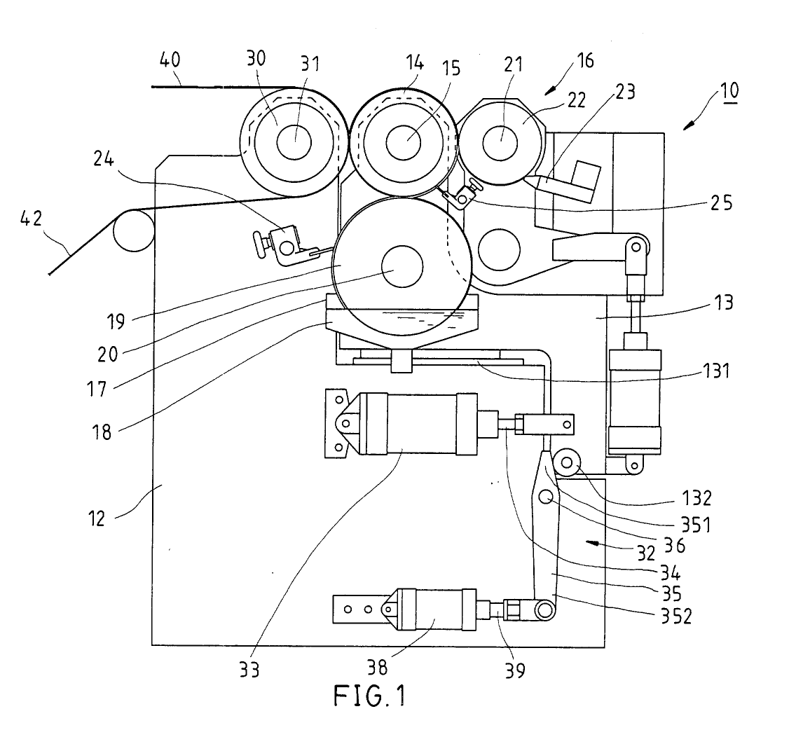

Referring to FIGS. 1˜3, a resin coated carrier fabrication apparatus 10 according to the first embodiment of the present invention is shown for fabricating a resin coated carrier 40, which comprises a tape of carrier 42(formed of copper foil or PET film, for example) and a layer of resin 44 coated over one side of the tape of carrier 42, leaving a blank area 45 surrounding the layer of resin 44. The apparatus 10 comprises a frame 12, a material-transferring cylinder 14, a metered material feeder 16, an impression cylinder 30, and a driving mechanism 32.

The material-transferring cylinder 14 is rotatably mounted on a rack 13 by a pivot shaft 15. The rack 13 is supported on a linear bearing 131 at the frame 12 for reciprocatly sliding. The material-transferring cylinder 14 is rotatable in counter-clockwise direction.

The metered material feeder 16 comprises a container 17 mounted on the frame 12 and adapted for holding a bonding agent 18, an applicator 19 rotatably mounted on the frame 12 below the material-transferring cylinder 14 by a pivot shaft 20, a scraping wheel 22 rotatably mounted on the frame 12 besides the material-transferring cylinder 14 by a pivot shaft 21, and a scraper blade 23 mounted on the rack 13 and stopped at the periphery of the scraping wheel 22. The bonding agent 18 is obtained from but not limited to, for example, epoxy resin. The applicator 19 is partially dipped in the bonding agent 18 and spaced from the periphery of the material-transferring cylinder 14 by a predetermined gap d1. When the applicator 19 rotated clockwise, it picks up the bonding agent 18 with the peripheral wall. When the thickness of the bonding agent 18 at the periphery of the applicator 19 surpasses the width of the gap d1, the bonding agent 18 is transferred to the periphery of the material-transferring cylinder 14. The scraping wheel 22 is peripherally spaced from the material-transferring cylinder 14 by a predetermined gap d2. The scraping wheel 22 is rotated counter-clockwise to carry excessive amount of the bonding agent 18 from the material-transferring cylinder 14, keeping the thickness of the bonding agent 18 at the periphery of the material-transferring cylinder 14 within a predetermined thickness d2. The scraper blade 23 is adapted to remove the bonding agent 18 from the scraping wheel 22 for recycling. By means of the aforesaid arrangement, the metered material feeder 16 applies the bonding agent 18 to the periphery of the material-transferring cylinder 14 subject to the predetermined thickness d2.

During fabrication, a flat scraper 24 may be mounted on the frame 12 and spaced from the periphery of the applicator 19 for removing excessive amount of the bonding agent 18 from the applicator 19, preventing accumulation of excessive amount of the bonding agent 18 between the applicator 19 and the material-transferring cylinder 14. The flat scraper 24 is not requisite, and can be eliminated.

The impression cylinder 30 is rotatably mounted on the frame 12 by a pivot shaft 31, and adapted for transferring the carrier 42 forward. The impression cylinder 30 is made of elastic material, for example, rubber. When the carrier 42 extended over the periphery of the impression cylinder 30, it is maintained spaced from the periphery of the material-transferring cylinder 14 by a gap d3. When the carrier 40 continuously delivered forwards, the impression cylinder 30 is rotated counter-clockwise to guide movement of the carrier 40. Alternatively, the impression cylinder 30 can be made not rotatable because the tape of carrier 42 is delivered by other transmission means, which is not described herein in detail because it is not within the scope of the present invention.

The driving mechanism 32 comprises a first air cylinder 33, a swivel arm 35, and a second air cylinder 38 all mounted on said frame 12. The first air cylinder 33 has a reciprocating rod 34 connected to the rack 13 for reciprocating the rack 13 along the linear bearing 131. The swivel arm 35 is rotatably mounted on the frame 12 by a pivot shaft 36, having a first end 351 stopped against the periphery of a stop rod 132 at the rack 13 and a second end 352 coupled to the reciprocating rod 39 of the second air cylinder 38. When the reciprocating rod 39 of the second air cylinder 38 retracted, the first end 351 of the swivel arm 35 is moved to the stop rod 132 to further move the rack 13 rightwards. On the contrary, when the reciprocating rod 39 of the second air cylinder 38 extended out, the first end 351 of the swivel arm 35 is returned, and the reciprocating rod 34 of the first air cylinder 33 is retracted to move the rack 13 leftwards. Therefore, the driving mechanism 32 is capable of moving the rack 13 forwards and backwards to adjust the gap between the material-transferring cylinder 14 and the impression cylinder 30.

In actual operation, use the metered material feeder 16 to apply the bonding agent 18 to the periphery of the material-transferring cylinder 14 subject to the predetermined thickness d2, and at the same time extend the tape of carrier 42 over the impression cylinder 30, leaving a predetermined gap d3 between the material-transferring cylinder 14 and the tape of carrier 42, and then use the driving mechanism 32 to repeatedly adjust the gap between the material-transferring cylinder 14 and the impression cylinder 30. When the gap between the material-transferring cylinder 14 and the tape of carrier 42 became smaller than the thickness of the bonding agent 18 (i.e., d3<d2), the bonding agent 18 is adhered to the tape of carrier 42. On the contrary, when the gap between the material-transferring cylinder 14 and the tape of carrier 42 became greater than the thickness of the bonding agent 18 (i.e., d3>d2), the tape of carrier 42 is continuously delivered forwards, and the bonding agent 18 is not adhered to the tape of carrier 42, thereby causing a blank area 45 left on one side of the tape of carrier 42. By means of repeatedly adjust the gap between the material-transferring cylinder 14 and the impression cylinder 30, the desired layer of resin 44 and blank area 45 are formed on one side of the tape of carrier 42.

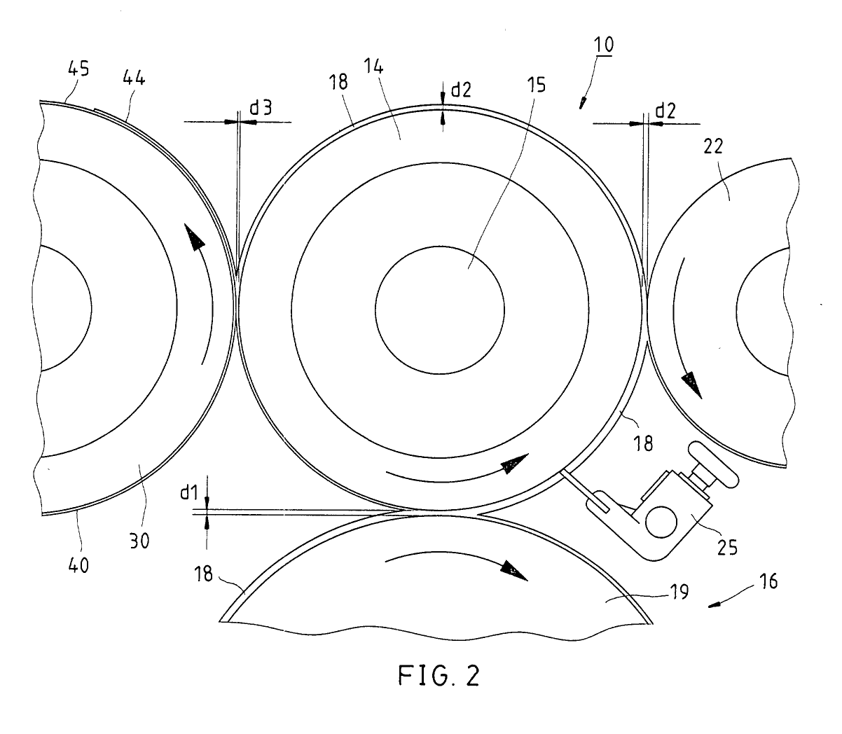

The apparatus of the present invention enables the operator to repeatedly adjust the gap between the material-transferring cylinder 14 and the impression cylinder 30, leaving a transverse blank area 451 between each two adjacent layer of resin 44. If desired, longitudinal blank areas 452 can be left on one side of the tape of carrier 42 along two long side edges of the tape of carrier 42. As illustrated in FIG. 2, a pair of scrapers 25 are installed on the frame 12 and pressed on the periphery of the material-transferring cylinder 14. The pitch w1 of the scrapers 25 is smaller than the width w2 of the tape of carrier 42 so that two longitudinal blank areas 452 are left on one side of the tape of carrier 42 when the bonding agent 18 applied to the tape of carrier 42 by the material-transferring cylinder 14 to form the desired layer of resin 44 of width w1 (w1<w2). Alternatively, the applicator 19 or the material-transferring cylinder 14 can be made having the width w1. In this case, the aforesaid scrapers 25 can be eliminated. The aforesaid two designs can control the pattern of the layer of resin 44 with two longitudinal blank areas 452 left on one side of the tape of carrier 42.

When the resin coated carrier 40 finished, it is cut into resin coated carrier units, each unit having a layer of resin 44 surrounded by a blank area 45. When one resin coated carrier unit adhered to a substrate, the respective layer of resin 44 is partially forced to diffuse by the applied pressure. However, because a blank area 45 is provided around the layer of resin 44, the layer of resin 44 does to flow out of the border of the resin coated carrier unit. Therefore, when using the resin-coated carrier units, it is not necessary to add a release film to the lens board.

The aforesaid driving mechanism may be various embodied. For example, the driving mechanism can be coupled to the impression cylinder and controlled to move the impression cylinder relative to the material-transferring cylinder so as to adjust the pitch between the impression cylinder and the material-transferring cylinder.

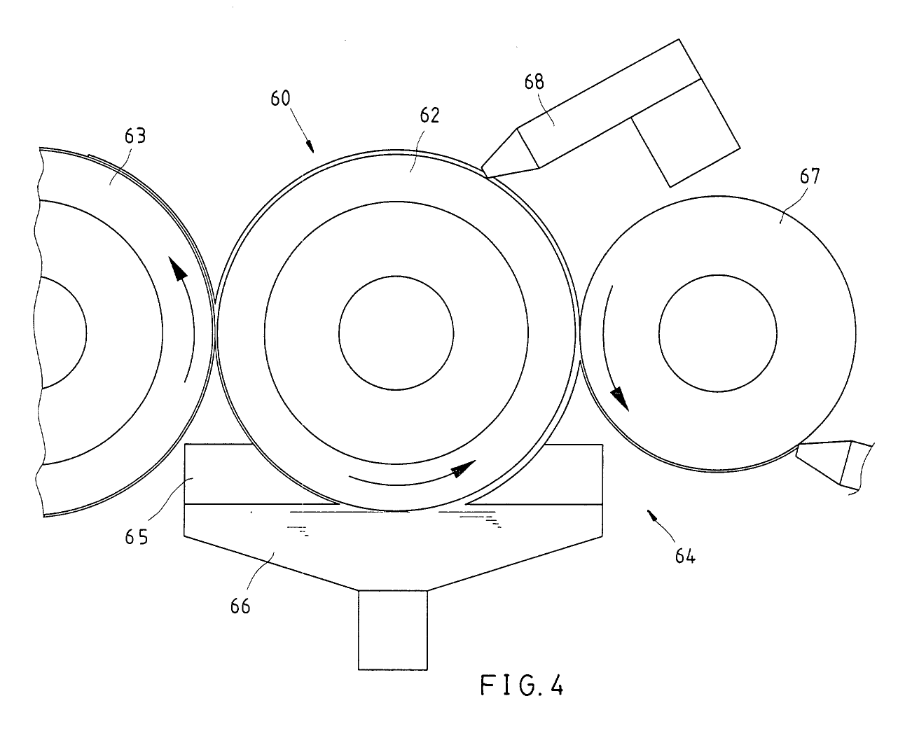

The aforesaid metered material feeder may also be variously embodied. FIG. 4 shows resin coated carrier fabrication apparatus 60 according to the second embodiment of the present invention. The resin coated carrier fabrication apparatus 60 comprises a material-transferring cylinder 62, an impression cylinder 63, and a metered material feeder 64. The metered material feeder 64 comprises a container 65 holding a bonding agent 66, a scraping wheel 67 at one side of the material-transferring cylinder 62, and a pair of scrapers 68 pressed on the periphery of the material-transferring cylinder 62 for removing the bonding agent 66 from two opposite lateral sides of the periphery of the material-transferring cylinder 62. This alternate form eliminates the aforesaid applicator, and enables the material-transferring cylinder 62 to directly pick up the bonding agent 66 from the container 65. The scraping wheel 67 is adapted for removing excessive amount of the bonding agent 66 from the periphery of the material-transferring cylinder 62. Therefore, the bonding agent 66 can be uniformly applied to the periphery of the material-transferring cylinder 62 subject to the desired thickness.

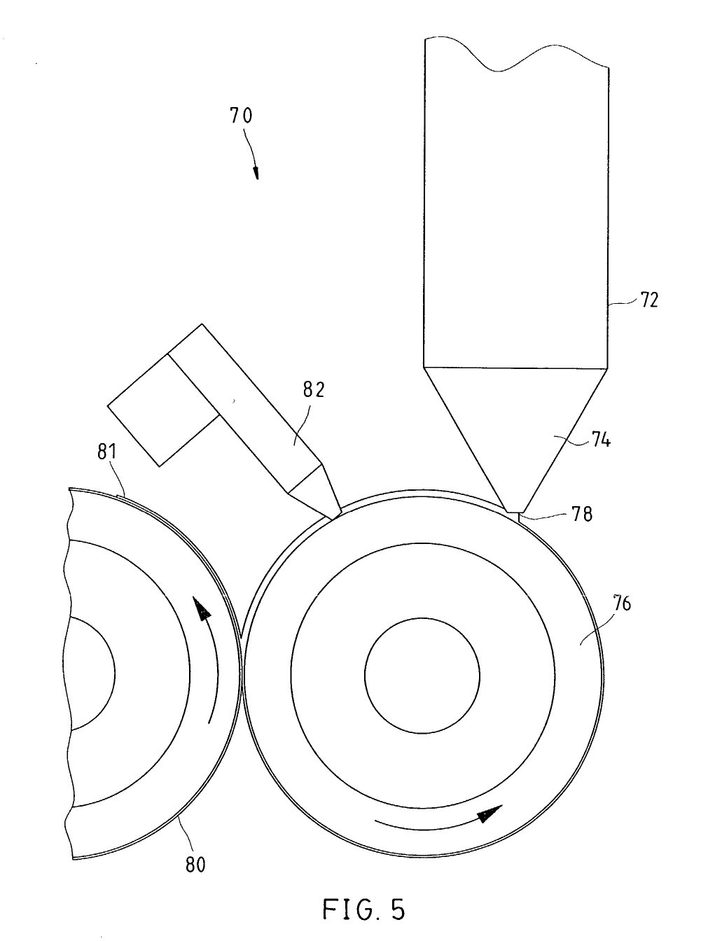

FIG. 5 shows resin coated carrier fabrication apparatus 70 according to the third embodiment of the present invention. The resin coated carrier fabrication apparatus 70 uses an electronically (or mechanically) controlled metered material feeder 72 to apply the bonding agent 74 to the periphery of the material-transferring cylinder 76 at a constant speed, enabling the bonding agent 74 to be uniformly covered over the periphery of the material-transferring cylinder 76 subject to a desired thickness. The bonding agent 74 is delivered out of a narrow elongated outlet 78 to the periphery of the material-transferring cylinder 76. The extending direction of the outlet 78 is in parallel to the axis of the material-transferring cylinder 76. The length of the outlet 78 can be made smaller than the width of a carrier 80. Alternatively, two scrapers 82 may be used to remove the bonding agent from two lateral sides of the periphery of the material-transferring cylinder 76. When the desired layer of resin 81 formed on one side of the carrier 80, a bank area is left around the layer of resin 81. This embodiment eliminates the use of the aforesaid applicator and scraping wheel.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. A resin coated carrier fabrication method comprising the steps of:
(a) applying a layer of bonding agent to a periphery of a continuously rotated material-transferring cylinder subject to a predetermined thickness through a metered material feeder, and at the same time extending a tape of carrier over an impression cylinder and continuously delivering said tape of carrier forwards and keeping a predetermined gap between said tape of carrier and the periphery of said material-transferring cylinder;
(b) adjusting the gap between said material-transferring cylinder and said carrier for enabling said bonding agent to be transferred from said material-transferring cylinder to said tape of carrier when the gap between said material-transferring cylinder and said carrier becomes smaller than the thickness of said layer of bonding agent at the periphery of said material-transferring cylinder and, for enabling a blank area to be left in said tape of carrier when the gap between said material-transferring cylinder and said carrier becomes greater than the thickness of said layer of bonding agent at the periphery of said material-transferring cylinder; and
(c) repeating step (b) so as to form said tape of carrier into a resin coated carrier having a layer of said bonding agent on one side thereof surrounded by a blank area.

2. The resin coated carrier fabrication method as claimed in claim 1, wherein said step (b) includes a sub-step of adjusting the width of said layer of bonding agent at the periphery of said material-transferring cylinder before transferring said bonding agent from said material-transferring cylinder to said carrier.

3. The resin coated carrier fabrication method as claimed in claim 1, wherein said bonding agent is a resin.

4. A resin coated carrier fabrication apparatus comprising:
a frame;
a rack sliderably reciprocatly mounted on said frame;
a material-transferring cylinder rotatably mounted on said rack;
a metered material feeder adapted for applying a layer of bonding agent to a periphery of said material-transferring cylinder according to a predetermined thickness;
an impression cylinder rotatably mounted on said frame and adapted for supporting a tape of carrier; and
a driving mechanism adapted for reciprocating said rack on said frame to adjust a gap between said material-transferring cylinder and said impression cylinder.

5. The resin coated carrier fabrication apparatus as claimed in claim 4, wherein said driving mechanism comprises a first air cylinder, a swivel arm and a second air cylinder all mounted on said frame, a reciprocating rod of said first air cylinder being mounted on said rack to reciprocate it, said swivel arm being rotatably mounted to said frame and coupled between said rack and a reciprocating rod of said second air cylinder.

6. The resin coated carrier fabrication apparatus as claimed in claim 4, wherein said metered material feeder comprises a container mounted on said frame and holding said bonding agent, an applicator mounted on said frame below said material-transferring cylinder, and a scraping wheel mounted on said rack besides said material-transferring cylinder, said applicator being partially dipped in said bonding agent and keeping a predetermined gap between said applicator and said material-transferring cylinder, said bonding agent being attached to a periphery of said applicator then applying to the periphery of said material-transferring cylinder when said applicator rotated, said scraping wheel being adapted for removing excessive amount of said bonding agent from the periphery of said material-transferring cylinder for enabling said bonding agent to be covered over the periphery of said material-transferring cylinder according to a predetermined thickness.

7. The resin coated carrier fabrication apparatus as claimed in claim 6, wherein the width of said applicator is smaller than the width of the tape of carrier to be supported on said impression cylinder.

8. The resin coated carrier fabrication apparatus as claimed in claim 6, further comprising a pair of scrapers respectively mounted on said frame and spaced from each other at a pitch smaller than the width of the tape of carrier to be supported on said impression cylinder and respectively pressed on the periphery of said applicator at two sides.

9. The resin coated carrier fabrication apparatus as claimed in claim 6, wherein the width of said material-transferring cylinder is smaller than the width of the tape of carrier to be supported on said impression cylinder.

10. The resin coated carrier fabrication apparatus as claimed in claim 6, further comprising a pair of scrapers respectively mounted on said rack and spaced from each other at a pitch smaller than the width of the tape of carrier to be supported on said impression cylinder and respectively pressed on the periphery of said material-transferring cylinder at two sides.

11. The resin coated carrier fabrication apparatus as claimed in claim 6, further comprising a flat scraper mounted on said frame and spaced from the periphery of said applicator at a pitch and adapted for removing excessive amount of said bonding agent from the periphery of said applicator for enabling said bonding agent to be covered on the periphery of said applicator subject to a predetermined thickness.

12. The resin coated carrier fabrication apparatus as claimed in claim 4, wherein said metered material feeder comprising a container holding a bonding agent in which said material-transferring cylinder is peripherally partially dipped, a scraping wheel mounted on said rack besides said material-transferring cylinder and adapted for removing excessive amount of said bonding agent from the periphery of said material-transferring cylinder.

13. The resin coated carrier fabrication apparatus as claimed in claim 12, wherein the width of said material-transferring cylinder is smaller than the width of the tape of carrier to be supported on said impression cylinder.

14. The resin coated carrier fabrication apparatus as claimed in claim 12, further comprising a pair of scrapers mounted on said rack and spaced from each other at a pitch smaller than the width of the tape of carrier to be supported on said impression cylinder and respectively pressed on the periphery of said material-transferring cylinder at two sides.

15. The resin coated carrier fabrication apparatus as claimed in claim 4, wherein said metered material feeder comprises a container holding a bonding agent, and a narrow elongated outlet extended in direction in parallel to the axis of said material-transferring cylinder and adapted for delivering said bonding agent from said container to the periphery of said material-transferring cylinder.

16. The resin coated carrier fabrication apparatus as claimed in claim 15, wherein the length of said outlet is smaller than the width of the tape of carrier to be supported on said impression cylinder.

17. The resin coated carrier fabrication apparatus as claimed in claim 15, further comprising a pair of scrapers mounted on said rack and spaced from each other at a pitch smaller than the width of the tape of carrier to be supported on said impression cylinder and respectively pressed on the periphery of said material-transferring cylinder at two sides.
